(19) United States
(12) Patent Application Publication
(10) Pub. No.: US 2017/0169186 A1
(43) Pub. Date: Jun. 15, 2017

(54) SYSTEM AND METHOD FOR PRESCRIPTION DRUG MANAGEMENT

(71) Applicant: SRINIVAS TUMMA, Fremont, CA (US)

(72) Inventor: SRINIVAS TUMMA, Fremont, CA (US)

(21) Appl. No.: 15/374,921

(22) Filed: Dec. 9, 2016

Related U.S. Application Data
(60) Provisional application No. 62/266,133, filed on Dec. 11, 2015.

(51) Int. Cl. G06F 19/00; G06F 21/62; G06F 21/60

(52) U.S. Cl. CPC G06F 19/3456; G06F 21/602; G06F 21/6245; G06F 19/328

(57) ABSTRACT

A system is provided. The system includes a central server. The central server houses medical information on a patient. The central server may be in communication with a plurality of computing systems. The plurality of computing systems may be configured with a user interface. The user interface enables a plurality of stake holders to view, add, retrieve, and edit medical information on a patient in the central server. The central server may be configured for analysing and managing the medical information on the patient and for sending prescription drug management and medication compliance alerts to the different stake holders in reference to the medical information of the patient.

### CROSS-REFERENCE TO RELATED APPLICATIONS

The present Utility patent application claims priority benefit of the U.S. provisional application for patent Ser. No. 62/266,133 titled “SYSTEM AND METHOD FOR PRESCRIPTION DRUG MANAGEMENT”, filed on Dec. 11, 2015 under 35 U.S.C. 119(e). The contents of this related provisional application are incorporated herein by reference for all purposes to the extent that such subject matter is not inconsistent herewith or limiting hereof.

### FIELD OF INVENTION

The present invention is directed to a system and a method for prescription drug management. More particularly the present invention is directed to a system and a method for managing round the clock (24 by 7) dispensing of prescription drugs that is aimed to assist a person in need of the prescription drugs.

### BACKGROUND OF INVENTION

Lifestyle diseases today have resulted in may people having to make prescribed medication a part of their daily routine. Medical compliance by all the parties involved including the medical practitioner, user requiring medical attention, pharmacists, and insurance providers is a never ending challenge.

Thus there is a need for an improved system and a method for prescription drug management that is capable of integrating information on a set of comprehensive features with reference to prescription drug management needs for individuals/organizations and/or health care providers.

### SUMMARY OF INVENTION

In one embodiment, is provided a system. The system includes a central server. The central server houses medical information on a patient. The central server may be in communication with a plurality of computing systems. The plurality of computing systems may be configured with a user interface. The user interface enables a plurality of stake holders to view, add, retrieve, and edit medical information on a patient in the central server. The central server may be configured for analysing and managing the medical information on the patient and for sending prescription drug management and medication compliance alerts to the different stake holders in reference to the medical information of the patient.

In another embodiment, is provided a system. The system includes a central server with a designated computer program in communication with a plurality of computing systems. A first computing system from the plurality of computing systems may enable a medical practitioner with a first user interface. The medical practitioner may populate the first computing system with a medical prescription data of a patient. In one embodiment, is provided a system. A second computing system from the plurality of computing systems may enable the patient with a second user interface. The patient may be enabled to access the first computing system and download the medical prescription data of the patient to the second computing system using the second user interface. The patient may populate a third computing system with the medical prescription data of the patient. The third computing system from the plurality of computing systems may enable a pharmaceutical service provider with a third user interface. The pharmaceutical service provider may provide the patient with medication as prescribed in the patient's medical prescription data. The patient may populate the central server with a medical data of the patient. The central server may be configured for analysing and managing the medical information on the patient and for providing independent prescription drug management alerts and medical compliance alerts to the medical practitioner, patient, and pharmaceutical service provider. The first, second, and third user interface independently configured for allowing the medical practitioner, patient, and pharmaceutical service provider to access, verify, add, or delete data in varying degrees to ensure compliance with a prescription drug management system.

In yet another embodiment, is provided a non-transitory computer-readable storage medium with an executable program stored thereon, wherein the program instructs one or more processors to perform the following steps. A first step of creating a designated computer program in a plurality of computing systems. A second step of populating data in a computing system, by enabling a medical practitioner to use the user interface to populate a computing system of the medical practitioner with medical prescription data of a patient. A third step of populating data in a computing system, by enabling the patient to use the user interface to access a computing system of the patient to retrieve the medical prescription data of the patient. A fourth step of forwarding the medical prescription data of the patient to a computing system of a pharmaceutical service provider. A fifth step of populating data in a central server, by providing a central server in communication with the first, second, and third computing systems, wherein the central server is configured to store the medical prescription data of the patient. A sixth step of encrypting the medical prescription data in the central server and all the computing systems by providing access control and security. A seventh step of providing by the central computing system, independent medication management alerts to the medical practitioner, patient, and the pharmaceutical service provider. The medical prescription data in all the computing systems is encrypted, access controlled, and secure.

In still yet another embodiment, is provided a process. The process includes a first step of creating a patient account by registering in a central server. The central server comprises a designated computer program that enables the patient to register the patient's details. The process includes a second step of gathering the medical prescription data of the patient. The patient is enabled with a computing system, a designated computer program, and a user interface to gather the medical prescription data of the patient from a plurality of medical practitioners. The plurality of medical practitioners are enabled with a computing system, the designated computer program, and a user interface to upload the medical prescription data of the patient to the computing system. The process includes a third step of populating the central server with medical prescription data of the patient. The patient is enabled with a computing system, the designated computer program, and the user interface to populate the central server with the medical prescription data of the patient. The process includes a fourth step of sharing the medical prescription data with a plurality of pharmaceutical service providers. The patient is enabled with a computing system, the designated computer program, and the user interface to share the medical prescription data with the plurality of pharmaceutical service providers. The process includes a fifth step of receiving medication in accordance with the medical prescription. The plurality of pharmaceutical service providers are enabled with a computing system, the designated computer program, and a user interface to view the medical prescription data of the patient and provide the patient with the medication in accordance with the medical prescription of the patient. The process includes a sixth step of ensuring compliance and alerting the plurality of medical practitioners, the patient and the plurality of pharmaceutical service providers. The central server is enabled to provide relevant alerts to the medical practitioners, the patient and the pharmaceutical service providers. The central server is in communication with the computing systems of the medical practitioners, the patient, and the pharmaceutical service providers. The user interfaces are independently configured for allowing the medical practitioners, the patient, and the pharmaceutical service providers to access, verify, add, or delete the medical prescription data in varying degrees ensuring compliance with the prescription drug management system.

By employing the above disclosed system and method processes may be designed and built with the assumption that it may be possible to assist a stake holder to handle prescription drug management information in the central server that will be suitable to their respective need, irrespective of numerable parameters involved in prescription drug management.

### BRIEF DESCRIPTION OF FIGURES

FIG. 1 illustrates an exemplary system of prescription drug management, in accordance with an embodiment of the present invention;

FIG. 2 illustrates an architecture of an exemplary system of prescription drug management, in accordance with an embodiment of the present invention;

FIG. 3 is a flow chart illustrating an exemplary portion of a process of prescription drug management, in accordance with an embodiment of the present invention;

FIG. 4 is a flow chart illustrating an exemplary portion of a process of prescription drug management, in accordance with an embodiment of the present invention;

FIG. 5 is a flow chart illustrating an exemplary portion of a process of prescription drug management, in accordance with an embodiment of the present invention;

FIG. 6 is a flow chart illustrating an exemplary portion of a process of prescription drug management, in accordance with an embodiment of the present invention;

FIG. 7 is a block diagram illustrating an exemplary system for a portion of prescription drug management, in accordance with an embodiment of the present invention; and

FIG. 8 is a block diagram illustrating an exemplary system for a portion of prescription drug management, in accordance with an embodiment of the present invention.

### DETAILED DESCRIPTION

Embodiments of the invention as disclosed herein provide an improved system and method for prescription drug management. More particularly the present invention is directed to providing an enabling and improved system and a method for various stakeholders in the prescription drug dispensation management.

There are quite a few issues with prescription drug management. For example, patients who try to get more than prescribed particularly with respect to controlled/restricted substances; not taking medication as prescribed, like forgetting to take the medication, no money to buy the medication, and loss of medication/prescription; forgetting to carry the medication when you are travelling for business/pleasure; and managing the prescription post the first and subsequent visits to a doctor.

Accordingly, in one embodiment, is provided a system and method for managing drug management. The system includes a user interface capable of being used by different stake holders in a drug management system. The user interface may be accessed by the different stake holders using a computer system. The computer system in various embodiments may include any device that is capable of operating and providing an output like a computer system including a mobile, vending machines, and the like. The system also includes a central server. The central server houses information required on drug dispensation as required by various stake holders. The various stake holders may use the user interface accessible through the computer system to view, add, retrieve, and edit information in the central server.

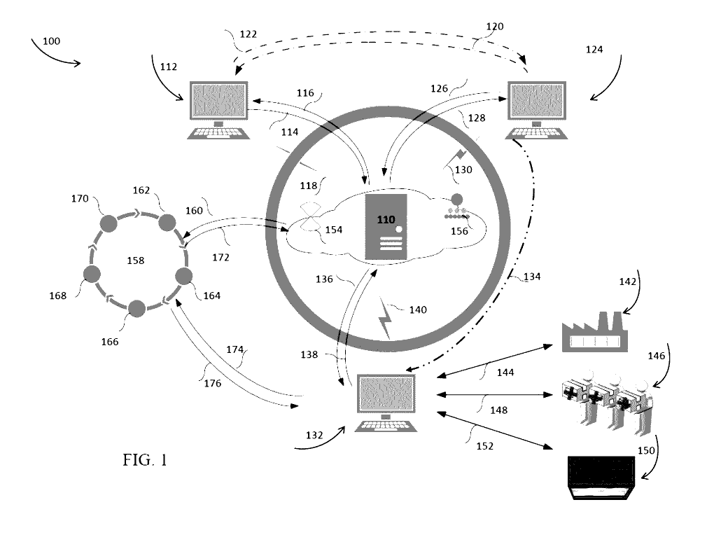

Referring to FIG. 1 is provided a system for prescription drug management. The system 100 includes a central server 110. The central server 110 with a designated computer program is in communication with a plurality of computing systems 112, 124, and 132. The system 100 includes a first computing system 112. The first computing system 112 from the plurality of computing systems enables a medical practitioner with a first user interface, i.e., a designated computer program. In one exemplary embodiment, the medical practitioner may populate the first computing system 112 with the medical information of a patient using the first user interface. In another embodiment the medical practitioner may be enabled to populate 114 the central server 110 with the medical information of a patient using the first computing system 112 and the first user interface. The medical practitioner may also be enabled to access the central server 110 and obtain medical information of the patient from 116 the central server. The central server 110 is in communication 118 with a plurality of computing systems one of which is the first computing system 112. In one embodiment (not shown in figure) the medical practitioner may be enabled to directly populate the second computing system with the medical information of the patient using the first computing system and the first user interface.

The system 100 further includes a second computing system 124. The second computing system 124 from the plurality of computing systems enables a patient with a second user interface, i.e., a designated computer program. In one exemplary embodiment, the patient is enabled 120 to access the first computing system 112 and download 122 the medical information of the patient to the second computing system 124 using the second user interface. In one embodiment, the patient may be enabled register with the central server 110 and to populate 126 the central server 110 with the medical information of the patient using the second computing system 124 and the second user interface. The patient may also be enabled to access the central server 110 and obtain the medical information of the patient from 128 the central server. The central server 110 is in communication 130 with a plurality of computing systems one of which is the second computing system 124.

The system 100 further includes a third computing system 132. The third computing system 132 from the plurality of computing systems enables a pharmaceutical service provider with a third user interface, i.e., a designated computer program. In one exemplary embodiment, the patient is enabled to share 134 the medical information of the patient with the pharmaceutical service provider using the second computing device 124 and the second user interface. In another embodiment, the pharmaceutical service provider is enabled to access 136 the central server 110 and download 138 the medical information of the patient to the third computing system 132 using the third user interface. The central server 110 is in communication 140 with a plurality of computing systems one of which is the third computing system 132. In various embodiments, the pharmaceutical service providers enabled with the third computing system 132 and the third user interface may include but are not limited to a pharmaceutical manufacturing company 142 enabled 144 with the third computing system and third user interface, a pharmacy/pharmacist 146 enabled 148 with the third computing system and third user interface, and a medication vending machine 150 enabled 152 with the third computing system and third user interface. The central server 110 is configured for analysing 154 and managing 156 the medical information on the patient. The central server 110 is also configured for providing medical compliance management. The medical compliance management includes a cyclic interface 158 where the central server 110 provides information 160 for the medical compliance management based on the analysis 154 of the medical information of the patient. The cyclic interface 158 includes monitor 162, alert 164, access 166, order 168 and dispense 170 interfaces that provide independent prescription drug management alerts and medical compliance alerts to the medical practitioner, patient, and pharmaceutical service provider.

For example, once a patient receives the medication the medication may be taken based on a reminder alert generated by the medical compliance management cyclic interface 158 that is communicated 172 to the central server 110 and communicated 130 by the central server 110 to the second computing system 124. The patient may use the alerts from the central server 110 to take the medication, for example, from a supply of the medication with the patient or from a time based dosage vending machine accessible to the patient. In various embodiments, the monitoring of medication usage and ensuring compliance of usage may be achieved in various manners as is known to persons skilled in the art and the technology available today. In one embodiment, the monitoring may be achieved by data 174 on the fill/refill provided to the cyclic interphase 158 by the pharmaceutical service provider, which data is in turn provided 172 by the cyclic interphase 158 to the central server 110. For example, the monitoring may be achieved by using computing systems like wearables or body monitors attached in/out the body using the internet, or through similar connected technology using the mobile or self-transmittable monitoring device in communication with the cyclic interface for analysing the medication usage and compliance data and updating, for example, monitoring bodies like medical practitioner, insurance providers, and statutory bodies if required.

In an exemplary embodiment, during the working of system 100 the medical practitioner may include medical information, for example, medical prescription data for a patient in the registered patient account on the central server 110. The medical practitioner may receive alerts on medication usage and compliance from the cyclic interface 158 via the central system 110 and the first computing system 112. The medical practitioner may view the use and past drug information and past history and prescribe appropriation medication and dosage to the patient. The patient is thus enabled to smoothly transition from one medical practitioner to another without any complications of misdiagnosis or ill-prescription of medication when deemed necessary, for example, when moving place of residence, or while travelling, etc. . . .

In an exemplary embodiment, during the working of the system 100, the pharmaceutical service providers provide the prescribed medications to the patients (fill/refill). In one embodiment, the pharmaceutical service providers may also update 138 the central server 110 with data on the fill/refill of the medication provided to the patients. In another embodiment, the pharmaceutical service provider may update 174 the cyclic interface 158 with the data on the fill/refill of the medication provided to the patients. The cyclic interface 158 may provide 176 the alert on the monitoring of the drug usage of the patient to the pharmaceutical service provider and the pharmaceutical service provider may ensure the access/availability of the medication and accordingly accept the order from the patient and dispense the medication when required. In certain embodiments, particularly when the patient is travelling and needs very specific non-OTC (over the counter) mediation, the pharmaceutical companies may deliver the medication to the patient/accessible pharmacy on demand from the patient generated by the patient via the second user interface and the central server or may populate a vending machine accessible to the patient with the necessary medication based on the demand. It may be appreciated by a person with ordinary skill in the art, in accordance with the present invention, that pharmaceutical manufacturing companies may employing current technologies, send cartridges to the patients or pharmacy to print the prescribed tailored medication using 3D printing at pharma location and/or patient location. In an alternate embodiment, vending machines may be employed to deliver the medication to the patient in the form of pre-manufactured medication or tailored medication by printing on demand using 3D printing or similar technology that allows to dispense the on demand medication. The central server 110 thus uses the designated computer program to integrate, analyse, and manage real time information on the medication for the patient from multiple sources including medical practitioner, patient, and pharmaceutical service provider and the updates and alerts generated by the cyclic interface, provides the necessary instructions to the medical practitioner, patient, and pharmaceutical service provider and other healthcare entities. The information may include changes, compliance requirements, refill requirement, etc. . . . In emergency situations, the central server 110 may also be configured to send information for critical care/ambulance or to family members for assistance. The system 100 assists patients to obtain medication on the go, if they forget to carry etc. . . . . The first, second, and third user interface may be independently configured for allowing the medical practitioner, patient, and pharmaceutical service provider to access, verify, add, or delete data in varying degrees to ensure compliance with a prescription drug management system.

In an exemplary embodiment, during the working of the system, the patient may make a request and authorize the medical practitioner to send the medical information of the patient to the patient's account (created by the patient during registration in the central server) in the central server 110. The patient may then share the medical information, for example, medical prescription with any pharmaceutical service provider 132.

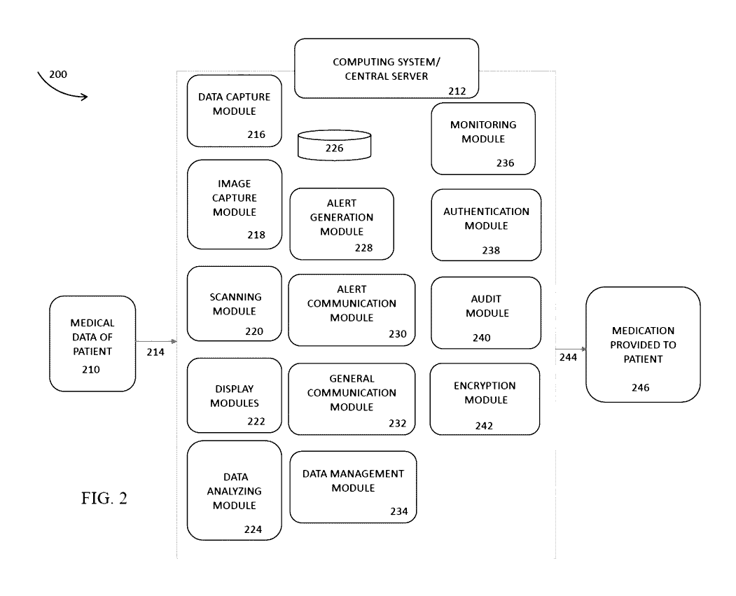

FIG. 2 illustrates an architecture of an exemplary system of prescription drug management, in accordance with an embodiment of the present invention. A prescription drug management system architecture 200 may comprise a computing system 212 which may include without limitation a data capture module 216, an image capture module 218, a scanning module 220, a display module 222, a data analysing module 224, a database 226, an alert generation module 228, an alert communication module 230, a general communication module 232, a data management module 234, a monitoring module 236, an authentication module 238, an audit module 240, an encryption module 242. A data capture module 216 may have a means of recognizing and capturing data, such as, without limitation, sensors and/or a processing unit for gathering medical information (data) of a patient 210. An image capture module 218 may have a means of detecting and capturing an image, such as, without limitation, sensors and/or a processing unit for gathering medical information of a patient 210. A scanning module 220 may have a means of scanning an image or data sheet, such as, without limitation, a processing unit, a computer to execute computer code and/or algorithms from a non-transitory computer readable medium for gathering medical information of a patient 210. A display module 222 may have a means to display medical information of a patient 210, such as, without limitation, a display screen of a computing system. A data analysing module 224 may have a means of analysing an image or data, without limitation, a processing unit, or a computer to execute computer code and/or algorithms from a non-transitory computer readable medium for gathering medical information of a patient 210. An alert generation module 228 may have a means of processing an alert such as, without limitation, a processing unit, or a computer to execute computer code and/or algorithms from a non-transitory computer readable medium for medical information of a patient 210. An alert communication module 230 may have a means of communicating an alert such as, without limitation, a processing unit, or a computer to execute computer code and/or algorithms from a non-transitory computer readable medium for medical information of a patient 210. A general communication module 232 may have a means of communicating an alert such as, without limitation, a processing unit, or a computer to execute computer code and/or algorithms from a non-transitory computer readable medium for medical information of a patient 210. A data management module 234 may have a means of managing data such as, without limitation, a processing unit, or a computer to execute computer code and/or algorithms from a non-transitory computer readable medium for medical information of a patient 210. A monitoring module 236 may have a means of monitoring data such as, without limitation, a processing unit, or a computer to execute computer code and/or algorithms from a non-transitory computer readable medium for medical information of a patient 210. A data authentication module 238 may have a means of authenticating data such as, without limitation, a processing unit, or a computer to execute computer code and/or algorithms from a non-transitory computer readable medium for medical information of a patient 210. An audit module 240 may have a means of auditing data such as, without limitation, a processing unit, or a computer to execute computer code and/or algorithms from a non-transitory computer readable medium for medical information of a patient 210. An encryption module 242 may have a means of encrypting data such as, without limitation, a processing unit, or a computer to execute computer code and/or algorithms from a non-transitory computer readable medium for medical information of a patient 210.

The data capture, image capture, scanning, data analysing, alert generation, communication, management, monitoring, authenticating, audit, and encryption modules may access one or more databases 226 as part of executing computer code and/or algorithms to, respectively, gather medical data and provide medical prescription alerts and medical compliance alerts while providing 244 medication to a patient 246.

In one embodiment, a system for prescription drug management is provided. The system provides a round the clock care (24×7 Care) for a patient requiring medication. The complete medical/medication information for the patient may be stored on a central server, for example, a cloud server. In an exemplary embodiment, this information may be input in the central server by a medical practitioner or by a person authorized by the medical practitioner. In one embodiment, the medical information may be input only by the practitioner who is entitled to write the medical information, for example, a medical prescription (electronically). Accordingly, in this embodiment, a patient may only transfer/share the medical information to a pharmacy from where the patient wants to collect medication in accordance with the medical prescription. A patient may not be given the authorization to modify/change/delete the prescription copy and transactional history. A patient may only view and share as needed a pharmacy/vending machine to get the due/courtesy medication. The prescription may be in un-editable format. In one embodiment, a pharmacy may view the medical information and past delivery medication history to dispense a medication as included in the medical prescription by a physician. The pharmacy may then update the prescription dispensed as a transaction in the central server.

In various embodiment, the system disclosed herein may provide access to add, read, edit, depending on who is using the system. Access control may be formalized by the medical practitioner, the patient, and any other stakeholder based on statutory regulations and compliance. This information may be shared with any pharmacy/drug store using the patient name under authorization by the patient. The prescription for the patient may be centrally managed using information saved in the central server—including usage information, refill information, etc. . . . Round the clock delivery of the prescription medication may be achieved by integrating pharmacist vending machines in addition to the stores themselves. The system may also include an online physician for emergency drugs as a temporary or one-time courtesy afforded by the pharmacists when the patient is not in a situation to contact his/her registered medical practitioner/physician.

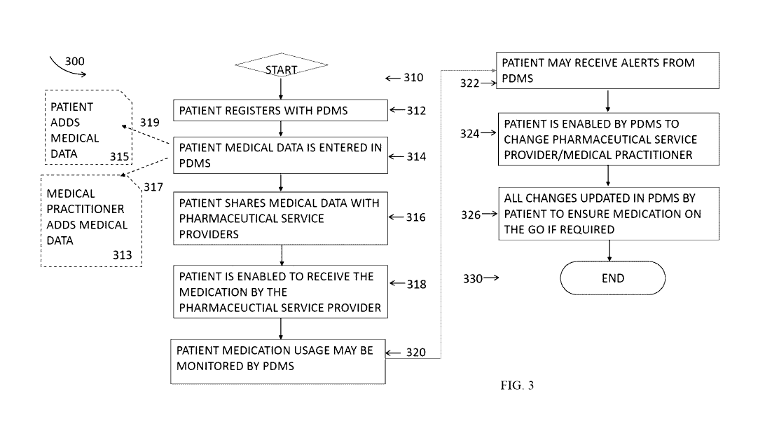

FIG. 3 is a flow chart illustrating an exemplary portion of a process of prescription drug management, in accordance with an embodiment of the present invention. In particular FIG. 3 provides the patient's actions and responsibilities in the process of prescription drug management. The process starts with a start step 310. In step 312 the patient registers the patient's details with the prescription drug management system 100 (PDMS) as described hereinabove. The patient may use a second computing system 124 enabled with a designated computer program i.e., a second user interface to enter details for the registration. The registration details may include but are not limited to name, contact details, sex, race, religion, family health history, patient health history, patient habits, and other details that may help a medical practitioner determine the appropriate medication for any medical condition being experienced by the patient. In step 314 current/ongoing medical information is entered in the PDMS. The current medical information may be either 319 added by the patient 315 or added 317 by the medical practitioner 313 as described herein. In a step 316 the patient or person authorized by the patient may share the medical data with the pharmaceutical service providers. In a step 318 the patient is enabled to the receive the medication by the pharmaceutical service providers. In various embodiments, including but not limited to, the medication may be provided to the patient on a visit to the pharmacy, or the medication may be made available through online sources, or the medication may be sent to the patient at his/her residence by the pharmacy, or the medication may be collected by the patient from a vending machine maintained by a pharmaceutical company or by a pharmacy, or keeping in line with currently available technology the pharmaceutical company may provide the patient/pharmacy with 3D printing cartridges for printing of the medication, and the like methods of delivering medication to a patient. In a step 320 the medication usage by the patient may be monitored by the PDMS. The monitoring may be achieved by various methods as may be known to a person skilled in the art in accordance with embodiments of the instant invention. In one embodiment, the monitoring may be simply achieved by usage information supplied by the patient in the central server 110. In another embodiment, the monitoring may be achieved using monitoring devices including, but not limited to, wearables, implants, and the like using which the cyclic interphase 158 monitors the medication usage of the patient and provides the information 172 to the central server 110 (PDMS). In certain embodiments, the monitoring may also be achieved by the fill/refill information provided by the pharmaceutical service providers to the cyclic interphase via the central server or to the central server via the cyclic interphase. In step 322 the patient may receive alerts from the PDMS. In various embodiments the alerts may include but are not limited to reminder alerts to take the medication, dosage alerts, alerts to indicate a refill is needed in a particular time period, alerts to remind for shifting physician or pharmacy while travelling, alerts on insurance compliance, alerts on statutory compliance for medication usage, and the like. In step 324 the PDMS provides a platform for the patient to make changes to his/her medical service providers including but not limited to the medical practitioner, pharmaceutical service provider, insurance provider, and the like. In step 326 all changes made by the patient are updated to the PDMS/central server to ensure uninterrupted supply of medication to the patient 24×7 irrespective of the location of the patient. The patient's roles and responsibilities in the process ends at step 330 and may start again at step 310 when the patient is in need of medication or making changes to his/her medical service providers for reasons discussed herein.

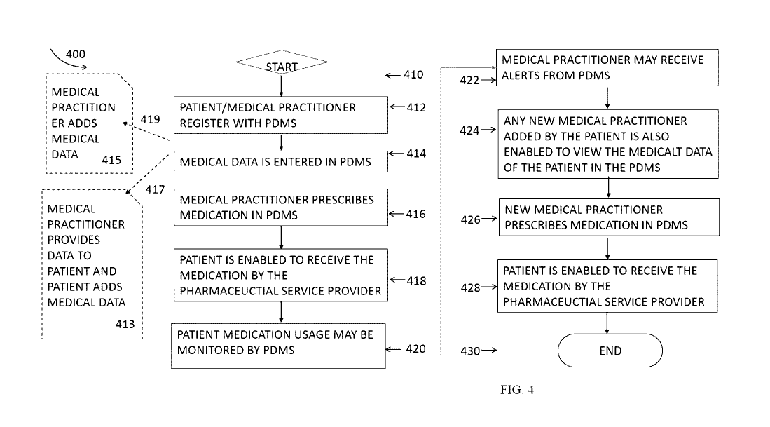

FIG. 4 is a flow chart illustrating an exemplary portion of a process of prescription drug management, in accordance with an embodiment of the present invention. In particular FIG. 4 provides the medical practitioner's actions and responsibilities in the process of prescription drug management. The process starts with a start step 410. In step 412 the medical practitioner registers the medical practitioner's details with the prescription drug management system 100 (PDMS) in the central server 110 as described hereinabove. In certain embodiments, the patient may also enter the details of the medical practitioner in step 412 if authorized by the medical practitioner. The medical practitioner may use a first computing system 112 enabled with a designated computer program i.e., a first user interface to enter details for the registration. The registration details may include but are not limited to name, contact details, sex, race, religion, qualifications of the practitioner, practice areas, specialities, availabilities, and other details of the medical PR actioner that may help a patient determine the appropriate medical practitioner for any medical condition being experienced by the patient. In step 414 current/ongoing medical information of the patient is entered in the PDMS. The current medical information may be either 419 added by the medical practitioner 415 or added 417 by the patient 413 once the medical practitioner provides the medical data to the patient as described herein. In a step 416 the medical practitioner may provide medical prescription based on the medical data and add this information in the PDMS. In a step 418 the patient is enabled to the receive the medication by the pharmaceutical service providers. In various embodiments, including but not limited to, the medication may be provided to the patient on a visit to the pharmacy, or the medication may be made available through online sources, or the medication may be sent to the patient at his/her residence by the pharmacy, or the medication may be collected by the patient from a vending machine maintained by a pharmaceutical company or by a pharmacy, or keeping in line with currently available technology the pharmaceutical company may provide the patient/pharmacy with 3D printing cartridges for printing of the medication, and the like methods of delivering medication to a patient. In a step 420 the medication usage by the patient may be monitored by the PDMS. The monitoring may be achieved by various methods as may be known to a person skilled in the art in accordance with embodiments of the instant invention. In one embodiment, the monitoring may be simply achieved by usage information supplied by the patient in the central server 110. In another embodiment, the monitoring may be achieved using monitoring devices including, but not limited to, wearables, implants, and the like using which the cyclic interphase 158 monitors the medication usage of the patient and provides the information 172 to the central server 110 (PDMS). In certain embodiments, the monitoring may also be achieved by the fill/refill information provided by the pharmaceutical service providers to the cyclic interphase via the central server or to the central server via the cyclic interphase. In step 422 the medical practitioner may receive alerts from the PDMS. In various embodiments the alerts may include but are not limited to, alerts to indicate if the patient has missed a dose of medication, alerts to make changes to dosage, alerts to indicate need for a refill prescription in a particular time period, alerts to show that the patient has shifted physician or pharmacy while travelling, alerts on patient's insurance compliance, alerts on statutory compliance for medication prescription, and the like. In step 424 the PDMS provides a platform for the any new medical practitioner added by the patient to view the past medical information of the patient and update/make changes to the patient's medical prescription with the patient's consent based on current medical data in step 426 to ensure uninterrupted supply of medication to the patient 24×7 irrespective of the location of the patient. In step 428 a patient is to receive the medication by the pharmaceutical service providers. The to ensure uninterrupted supply of medication to the patient 24×7 irrespective of the location of the patient's roles and responsibilities in the process ends at step 430 and may start again at step 410 when the patient is in need of medication or making changes to his/her medical service providers for reasons discussed herein.

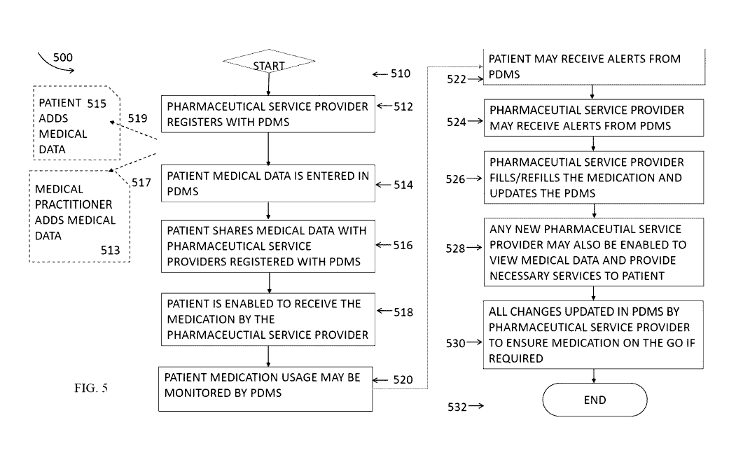

FIG. 5 is a flow chart illustrating an exemplary portion of a process of prescription drug management, in accordance with an embodiment of the present invention. In particular FIG. 5 provides the pharmaceutical service provider's actions and responsibilities in the process of prescription drug management. The process starts with a start step 510. In step 512 the pharmaceutical service provider registers the pharmaceutical service provider's details with the prescription drug management system 100 (PDMS) in the central server 110 as described hereinabove. In certain embodiments, the patient may also enter the details of the pharmaceutical service provider in step 512 if authorized by the pharmaceutical service provider. The pharmaceutical service provider may use a third computing system 132 enabled with a designated computer program i.e., a third user interface to enter details for the registration. The registration details may include but are not limited to name, contact details, sex, race, religion, qualifications of the pharmaceutical service provider, multiple location details, working hours, and other details of the pharmaceutical service provider that may help a patient determine the appropriate pharmaceutical service provider depending on location and convenience of the patient. In step 514 current/ongoing medical information of the patient is entered in the PDMS. The current medical information may be either 519 added by the patient 515 or added 517 by the medical practitioner 513 patient as described herein. In a step 516 the patient may share the medical data with pharmaceutical service provider registered with the PDMS and as convenient to the patient based on his/her location. In a step 518 the patient is enabled to the receive the medication by the pharmaceutical service providers. In various embodiments, including but not limited to, the medication may be provided to the patient on a visit to the pharmacy, or the medication may be made available through online sources, or the medication may be sent to the patient at his/her residence by the pharmacy, or the medication may be collected by the patient from a vending machine maintained by a pharmaceutical company or by a pharmacy, or keeping in line with currently available technology the pharmaceutical company may provide the patient/pharmacy with 3D printing cartridges for printing of the medication, and the like methods of delivering medication to a patient. In a step 520 the medication usage by the patient may be monitored by the PDMS. The monitoring may be achieved by various methods as may be known to a person skilled in the art in accordance with embodiments of the instant invention. In one embodiment, the monitoring may be simply achieved by usage information supplied by the patient in the central server 110. In another embodiment, the monitoring may be achieved using monitoring devices including, but not limited to, wearables, implants, and the like using which the cyclic interphase 158 monitors the medication usage of the patient and provides the information 172 to the central server 110 (PDMS). In certain embodiments, the monitoring may also be achieved by the fill/refill information provided by the pharmaceutical service providers to the cyclic interphase via the central server or to the central server via the cyclic interphase. In step 522 the patient may receive alerts from the PDMS. In various embodiments the alerts may include but are not limited to reminder alerts to take the medication, dosage alerts, alerts to indicate a refill is needed in a particular time period, alerts to remind for shifting physician or pharmacy while travelling, alerts on insurance compliance, alerts on statutory compliance for medication usage, and the like. In step 524 the pharmaceutical service providers may receive alerts from the PDMS. In various embodiments the alerts may include but are not limited to alerts to have medication ready for a paint in the pharmacy or the vending machine, alerts to indicate a refill is needed in a particular time period in a particular branch/vending machine of the pharmacy, alerts to inform pharmaceutical service providers that patient has shifted pharmaceutical service providers while travelling, alerts on insurance compliance, alerts on statutory compliance for medication usage, and the like. In step 526 the pharmaceutical service provider fills/refills the medication and updates the cyclic interface 158 and/or the central server 110. In step 528 any new pharmaceutical service provider may also be enabled to view the medical information necessary to update/make changes to the patient's medical prescription based on current medical data to ensure uninterrupted supply of necessary services to the patient 24×7 irrespective of the location of the patient. In step 530 a platform for the any new pharmaceutical service provider added by the patient to view the medical information of the patient and provide medication on the go to the patient is provided. The pharmaceutical service provider's roles and responsibilities in the process ends at step 532 and may start again at step 510 when the patient is in need of medication or making changes to his/her medical service providers for reasons discussed herein.

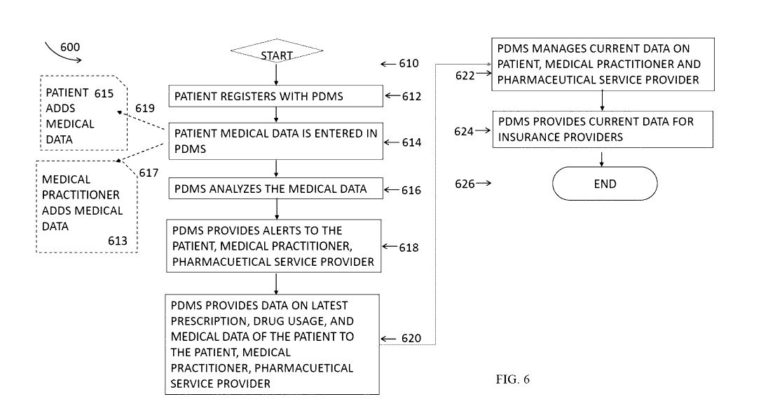

FIG. 6 is a flow chart illustrating an exemplary portion of a process of prescription drug management, in accordance with an embodiment of the present invention. In particular FIG. 6 provides the PDMS's actions and responsibilities in the process of prescription drug management. The process starts with a start step 610. In step 612 the patient registers the patient's details with the prescription drug management system 100 (PDMS) as described hereinabove. The patient may use a second computing system 124 enabled with a designated computer program i.e., a second user interface to enter details for the registration. The registration details may include but are not limited to name, contact details, sex, race, religion, family health history, patient health history, patient habits, and other details that may help a medical practitioner determine the appropriate medication for any medical condition being experienced by the patient. In step 614 current/ongoing medical information is entered in the PDMS. The current medical information may be either 619 added by the patient 615 or added 617 by the medical practitioner 613 as described herein. In a step 616 the PDMS analyses the medical data. The analysis may include but is not limited to, analysing medical history of patient, family medical history of patient, drug usage patterns of patient, drug usage compliance patterns of patient, fill/refill patterns of pharmaceutical service providers, medical prescription patterns of medical practitioners, and the like. In a step 618 the PDMS provides alerts to the patient, medical practitioners, and pharmaceutical service providers via central server 110 with reference to the actions and responsibilities of the patient, medical practitioners, and pharmaceutical service providers as described herein above. The PDMS via the central server 110 also provides data on latest medical prescription, drug usage, and medical data of the patient to the patient, medical practitioners, and pharmaceutical service provider in step 620. The PDMS via the central server 110 also manages the current data on patient, medical practitioners, and pharmaceutical service provider in step 622. In step 624 the PDMS may also provide information to/on insurance providers and on the statutory information required on medical prescriptions. The PDMS's roles and responsibilities in the process ends at step 630 and may start again at step 610 when the patient is in need of medication or making changes to his/her medical service providers for reasons discussed herein.

In one embodiment, if the patient wants to transfer their prescription from one pharmacy to another they may need to follow the following steps and all the relevant information is captured in the central server. This helps to ensure an updated prescription and refill handed over to the patient even in case of emergencies. The steps include request for a prescription transfer from a first pharmacy to a second pharmacy, contracting the first pharmacy for courtesy supplies, contracting physician for courtesy supplies, getting approval form physician for courtesy supplies, transferring prescription either to a different pharmacy or another prescription from the same chain of pharmacies.

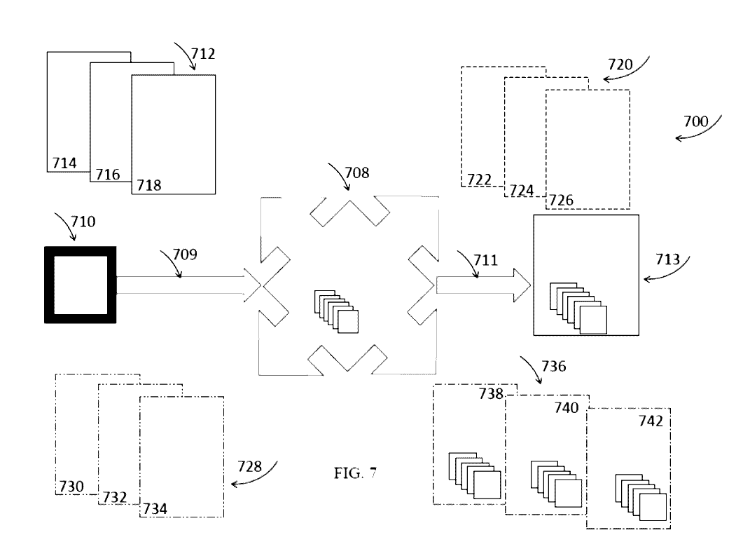

FIG. 7 is a block diagram illustrating an exemplary system 700 for a portion of prescription drug management, in accordance with an embodiment of the present invention. The system 700 shows how patient managing records 710 may be added by different entities. In one exemplary embodiment, the entities include medical practitioners i.e., physicians 712, pharmaceutical service providers 720, Insurance service providers 728, and statutory information databases 736.

In one embodiment, the physicians 712 may include a plurality of physicians based on the physicians visited by the patients. In various embodiments the patients may need to employ the services of a plurality of physicians for reasons including but not limited to travelling habits of the patient; travelling habits of the physician; need for physicians with multiple specialities; need to ensure zero or minimum conflicts to medications prescribed by multiple physicians; relocation of the patient; relocation of the physician; closure of a physician's facility; change of mind of the patient resulting in change of physician; change of mind of the physician resulting in the patient looking for a new physician; and the like. The physicians 712 may accordingly include physician-I 714, physician-II 716, physician-III 718, etc. . . . As discussed herein above each of the physicians may need to be registered with the central server 708. The central server 708 is a computing system with a designated computer program/user interface. The physicians 712 are enabled with a user interface to add/edit current medical data, view medical history, and perform other actions using the user interface with reference to the medical information of the patient stored in the central server 708, to ensure providing an appropriate medical prescription to the patient.

In one embodiment, the pharmaceutical service providers 720 may include a plurality of pharmaceutical service providers based on the pharmaceutical service providers visited/used by the patients. In various embodiments the patient may need to employ the services of a plurality of pharmaceutical service providers for reasons including but not limited travelling habits of the patient, relocation of the patient; need for pharmaceutical service providers with multiple medication brand availability, closure of a pharmaceutical service provider; relocation of a pharmaceutical service provider; change of mind of the patient with reference to a current pharmaceutical service provider resulting in patient looking for new pharmaceutical service provider; 24×7 medication availability, for example, for critical lifesaving medication, and the like. The pharmaceutical service providers 720 may accordingly include pharmaceutical service provider-I 722, pharmaceutical service provider-II 724, pharmaceutical service provider-III 726, etc. . . . As discussed herein above each of the pharmaceutical service provider may need to be registered with the central server 708. The central server 708 is a computing system with a designated computer program/user interface. The pharmaceutical service providers 720 are enabled with a user interface to view current medical data, view medical history, and perform other actions using the user interface with reference to the medical information of the patient stored in the central server 708, to ensure dispensing/filling/re-filling an appropriate medical prescription to the patient.

In one embodiment, the insurance service providers 728 may include a plurality of insurance service providers based on the insurance service providers available to the patients. In various embodiments the patient may need to employ the services of a plurality of insurance service providers 728 for reasons including but not limited to travelling habits of patient leading to dependence on insurance providers based on providing location based services, relocation of the patient leading to dependence on insurance providers based on providing location, i.e., country, state, city, etc. . . . based services, change in mind of patient on a current insurance service provider, i.e., based on comparison of cost of premiums offered by different insurance providers, based on service provided by the insurance service provider after a previous insurance claim, etc. . . . , need for insurance service providers providing insurance availability for various medical indications of the patient, 24×7 insurance provider back up availability, for example, for critical situations, and the like. The insurance service providers 728 may accordingly include insurance service provider-I 730, insurance service provider-II 732, insurance service provider-III 734, etc. . . . As discussed herein above each of the insurance service provider may need to be registered with the central server 708. The central server 708 is a computing system with a designated computer program/user interface. The insurance service provider 720 are enabled with a user interface to view current medical data, view medical history, and perform other actions using the user interface with reference to the medical information of the patient stored in the central server 708, to ensure providing an appropriate insurance package to the patient.

In one embodiment, the insurance service providers 728 may include a plurality of insurance service providers based on the insurance service providers available to the patients. In various embodiments, the patient may need to employ the services of a plurality of insurance service providers 728 for reasons including but not limited to travelling habits of patient leading to dependence on insurance providers based on providing location based services, need for insurance service providers providing insurance availability for various medical indications of the patient, 24×7 insurance provider back up availability, for example, for critical situations, and the like. The insurance service providers 728 may accordingly include insurance service provider-I 730, insurance service provider-II 732, insurance service provider-III 734, etc. . . . As discussed herein above each of the insurance service provider may need to be registered with the central server 708. The central server 708 is a computing system with a designated computer program/user interface. The insurance service provider 720 are enabled with a user interface to view current medical data, view medical history, and perform other actions using the user interface with reference to the medical information of the patient stored in the central server 708, to ensure providing an appropriate insurance package to the patient.

In one embodiment, the statutory information database 736 may include a plurality of statutory information databases based on the statutory information databases available to the patients in different locations and based on different medical indications. In various embodiments, the patient may need to employ the services of a plurality of statutory information databases 736 for reasons including but not limited to travelling habits of patient leading to dependence on statutory information databases based on providing location based statutory requirements, need for statutory information databases providing statutory information availability for various medical indications and medications of the patient, 24×7 statutory information provider back up availability, for example, for critical situations, and the like. The statutory information databases 736 may accordingly include statutory information database-I 738, statutory information database-II 740, statutory information database-III 742, etc. . . . As discussed herein above each of the information database may need to be registered with the central server 708. The central server 708 is a computing system with a designated computer program/user interface. The statutory information databases are enabled with a user interface to view current medical data, view medical history, and perform other actions using the user interface with reference to the medical information of the patient stored in the central server 708, to ensure providing an appropriate statutory requirement information package to the patient, medical practitioner, pharmaceutical service provider, and the insurance provider to ensure statutory compliance. The medical information is included 709 by various parties with authorisation to the central server 708. The data is further archived 711 and retained in a read only shadow or back up database 713 to ensure safe retrieval and security of information in times of need. In one exemplary embodiment, the medical information and data in both the central server 708 and the shadow database 713 are recorded in an audit log document that records an event in an information (IT) technology system. In addition to documenting what resources were accessed, audit log entries usually include destination and source addresses, a timestamp and user login/registration information that ensures security, reliability, and traceability of the data.

In various embodiments, as shown in FIG. 700, different stake holders may according to permission granted view, add, edit, delete, records in the central server 708. The changes made to the records are retained in the central server 708 and the backup database 713. The central server 708 also updates the copies held by all stake holders participating in that case at that moment and thereafter if there are any changes made to any document until the end of the life of the document-storage in the databases of the various stake holders for source of truth authentication. In one embodiment, the life of a document in the database may be determined by statutory laws that may need a particular period for holding the medical information documents in the central server, backup database, and the databases of the various stake holders. In one example, the documents may be retained and updated continuously till the death of a patient. In another example, the documents may be retained and updated continuously even after the death of a patient based on circumstances of death or for research purposes.

It will be clearly understood by those skilled in the art that the foregoing description has been made in terms only of the most preferred specific embodiments. Turning to FIG. 7, various scenarios may be possible. Few sample scenarios include:
Scenario—I—in case of one prescription one pharmacy may provide refills
Scenario—II—in case of different prescription different pharmacy may provide refill
Scenario—III—in case of one prescription different pharmacy may provide refills
Scenario—IV—in case of different physician, different prescription, but same pharmacy may provide refill
Scenario—V—in case of different physician, different prescription different, different pharmacy may provide refill
Scenario—VI—in case of different physician, different prescription, different pharmacy may refill, with different Insurance provider
Scenario—VII—in case of different physician, different prescription different pharmacy with different Insurance in different country

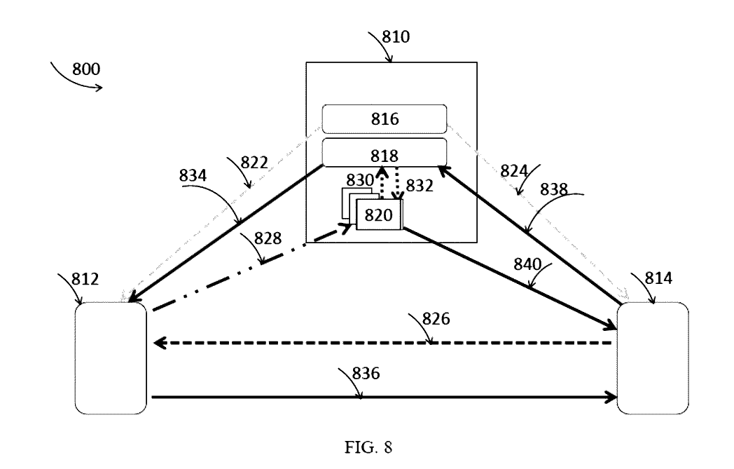

In an exemplary embodiment, referring to FIG. 8, a block diagram illustrating an exemplary system 800 for a portion of prescription drug management, in accordance with an embodiment of the present invention is provided. The system 800 includes a central server 810, a computing system accessible by a patient, i.e., a patient device 812, and a computing system accessible by a vendor, i.e., a vendor device 814. The central sever 810 includes a user authentication server 816, an encryption server 818, and the medical information records of the patient 820. The patient may register with the central server 810 using the patient device 812 and a designated computer program (installed on both the patient device and the central server). The central server 810 may provide the patient with a unique identification number (unique ID). Accordingly, the other stake holders as described herein above and the vendor (pharmaceutical service provider in this exemplary embodiment) may register with the central server 810 using the vendor device 814 and a designated computer program (installed on both the vendor device and the central server). The central server 810 may provide the vendor with a unique identification number (unique ID or UID). In various embodiments, the ID may include, but may not be limited to a UID, Quick Response code (QR code), bar code, and near field communication (NFC). Thus all the stake holders including the patient login in to the central server 810 based on statutory requirement with appropriate user authentications i.e., patient authentication 822 and vendor authentication 824. The patient may select a patient record 820 for sharing with the vendor 814. The patient device 812 may direct the patient to request for the vendor code/QR code and require 826 the entry of the code data by entering or scanning the details on the patient device. The patient device 812 may share 828 vendor ID along with the selected patient record 820 that needs to be shared 830 to the encryption server 818. The encryption server sends 832 the encrypted record link 834 to the patient to share 836 with the vendor through user ID or through the service provide message. The vendor device 814 connects 838 to the service provider encryption server 818 to unlock 840 and grant access to the patient record with predefined conditions, for example, time bound sharing, vendor (Stake holder) specific role privileges, etc. . . . . As discussed hereinabove the privileges afforded to the stake holders based on their role include create, drop, insert, update, archive, delete, etc. . . . based on what needs to be done with the medical information of the patient and by which stake holder.

In various embodiments, the medical information may include, but is not limited to, personal information of individual patients to information on advances in the medical industry. Each stake holder i.e., the patient, medial practitioner, pharmaceutical service provider, insurance provider, statutory information database, etc. . . . may use a computing system to access the central server housing the information via the user interface. The disclosure provides a system and method that may assist in making prescription drugs available round the clock to a patient, for example, uniting the pharmacies with e-business. Physicians, individuals/patients, organizations employing the individuals, pharmacies, laboratories, hospitals, and insurance companies may utilize this as a one-stop system for medication related information per their requirement. The system disclosed herein attempts to completely integrate medication providing services into a uniform platform.

The terminology used herein is for the purpose of describing particular exemplary embodiments only and is not intended to be limiting. As used herein, the singular forms “a”, “an” and “the” may be intended to include the plural forms as well, unless the context clearly indicates otherwise. The terms “comprises,” “comprising,” “including,” and “having,” are inclusive and therefore specify the presence of stated features, integers, steps, operations, elements, and/or components, but do not preclude the presence or addition of one or more other features, integers, steps, operations, elements, and/or components thereof. The method steps, processes, and operations described herein are not to be construed as necessarily requiring their performance in the particular order discussed or illustrated, unless specifically identified as an order of performance. It is also to be understood that additional or alternative steps may be employed.

As used herein the terms first, second, third, etc. . . . describe various elements or steps and these elements or steps should not be limited by these terms. These terms may be only used to distinguish one element or step from another element or step. Terms such as “first”, “second”, and other numerical terms when used herein do not imply a sequence or order unless clearly indicated by the context. Thus, a first step, first computer, or first user interface discussed below could be termed a second step, second computer, or second user interface without departing from the teachings of the exemplary embodiments.

A “computer” may refer to one or more apparatus and/or one or more systems that are capable of device that computes, especially a programmable electronic machine that performs high-speed mathematical or logical operations or that assembles, stores, correlates, or otherwise processes information. Examples of a computer may include: a computer; a desktop, a laptop; a computer having a single processor, multiple processors, or multi-core processors, a tablet personal computer (PC); a personal digital assistant (PDA); a portable telephone, and the like.

“Software” may refer to prescribed rules to operate a computer. Examples of software may include: code segments in one or more computer-readable languages; graphical and or/textual instructions; applets; pre-compiled code; interpreted code; compiled code; and computer programs.

Thus the instant disclosure provides a complete (post doctor visit) medication management including an up stream process of getting prescription from a physician, buying a prescribed drug from a pharmacy, managing your needs at different points in time at different pharmacies, and courtesy medication if required, etc.) and a downstream process (once you have the medication in hand—like alerts/reminders to manage usage, manage refill, manage courtesy medicines while travelling or in emergency, etc. . . . . In one embodiment, the appliances to help patients to remind and alert may use IoT—Internet of things

The foregoing embodiments meet the overall objectives of this disclosure as summarized above. However, it will be clearly understood by those skilled in the art that the foregoing description has been made in terms only of the most preferred specific embodiments. Therefore, many other changes and modifications clearly and easily can be made that are also useful improvements and definitely outside the existing art without departing from the scope of the present disclosure, indeed which remain within its very broad overall scope, and which disclosure is to be defined over the existing art by the appended claims.

We claim:

1. A system comprising;
a central server, wherein the central server houses medical information on a patient, wherein the central server is in communication with a plurality of computing systems;
wherein the plurality of computing systems are configured with a user interface;
wherein the user interface enables a plurality of stake holders to view, add, retrieve, and edit medical information on a patient in the central server;
the central server, configured for analysing and managing the medical information on the patient and for sending prescription drug management and medication compliance alerts to the different stake holders in reference to the medical information of the patient.

2. The system of claim 1, wherein the plurality of stake holders comprise at least one of a medical practitioner, a patient, and a pharmaceutical service provider.

3. A system comprising:
a central server with a designated computer program in communication with a plurality of computing systems;
a first computing system from the plurality of computing systems, enabling a medical practitioner with a first user interface, wherein the medical practitioner populates the first computing system with a medical prescription data of a patient;
a second computing system from the plurality of computing systems, enabling the patient with a second user interface, wherein the patient is enabled to access the first computing system and download the medical prescription data of the patient to the second computing system using the second user interface, wherein the patient populates a third computing system with the medical prescription data of the patient;
the third computing system from the plurality of computing systems, enabling a pharmaceutical service provider with a third user interface, wherein the pharmaceutical service provider provides the patient with medication as prescribed in the patient's medical prescription data;
wherein the patient populates the central server with a medical data of the patient;
the central server, configured for analysing and managing the medical information on the patient and for providing independent prescription drug management alerts and medical compliance alerts to the medical practitioner, patient, and pharmaceutical service provider; and
the first, second, and third user interface independently configured for allowing the medical practitioner, patient, and pharmaceutical service provider to access, verify, add, or delete data in varying degrees to ensure compliance with a prescription drug management system.

4. The system of claim 3, wherein the patient is enabled to access the first computing systems of a plurality of medical practitioners,

5. The system of claim 3, wherein the data in the first, second, and third computing system and the central server is encrypted and is available only on need to access basis.

6. The system of claim 3, wherein the patient is provided with a flexibility to change the medical practitioner and the pharmaceutical service provider, wherein the patient is enabled by one of the plurality of computing systems configured with a user interface to enter the change in the central server.

7. The system of claim 3, wherein the first user interface enables the medical practitioner to register with the central server.

8. The system of claim 3, wherein the second user interface enables the patient to register with the central server.

9. The system of claim 3, wherein the third user interface enables the pharmaceutical service provider to register with the central server.

10. The system of claim 3, further comprising a plurality of user interfaces for a plurality of stake holders who are interested parties in the prescription drug management system.

11. The system of claim 10, wherein the interested party is a medical insurance provider.

12. The system of claim 3, wherein the medical practitioner is authorized by the patient to use the first computing system, configured for interacting with the medical practitioner with the first user interface to populate the central server with the medical prescription data of the patient.

13. The system of claim 3, wherein the medical practitioner is authorized by the patient to use the first computing system, configured for interacting with the medical practitioner with the first user interface to populate the third computing system of the pharmaceutical service provider with the medical prescription data of the second stake holder.

14. A non-transitory computer-readable storage medium with an executable program stored thereon, wherein the program instructs one or more processors to perform the following steps:
creating a designated computer program in a plurality of computing systems;
populating data in a computing system, by enabling a medical practitioner to use the user interface to populate a computing system of the medical practitioner with medical prescription data of a patient;
populating data in a computing system, by enabling the patient to use the user interface to access a computing system of the patient to retrieve the medical prescription data of the patient;
forwarding the medical prescription data of the patient to a computing system of a pharmaceutical service provider;
populating data in a central server, by providing a central server in communication with the first, second, and third computing systems, wherein the central server is configured to store the medical prescription data of the patient;
encrypting the medical prescription data in the central server and all the computing systems by providing access control and security; and
providing by the central computing system, independent medication management alerts to the medical practitioner, patient, and the pharmaceutical service provider; wherein the medical prescription data in all the computing systems is encrypted, access controlled, and secure.

15. A process comprising:
creating a patient account by registering in a central server, wherein the central server comprises a designated computer program that enables the patient to register the patient's details;
gathering the medical prescription data of the patient, wherein the patient is enabled with a computing system, a designated computer program, and a user interface to gather the medical prescription data of the patient from a plurality of medical practitioners, wherein the plurality of medical practitioners are enabled with a computing system, the designated computer program, and a user interface to upload the medical prescription data of the patient to the computing system;
populating the central server with medical prescription data of the patient, wherein the patient is enabled with a computing system, the designated computer program, and the user interface to populate the central server with the medical prescription data of the patient;
sharing the medical prescription data with a plurality of pharmaceutical service providers, wherein the patient is enabled with a computing system, the designated computer program, and the user interface to share the medical prescription data with the plurality of pharmaceutical service providers;
receiving medication in accordance with the medical prescription, wherein the plurality of pharmaceutical service providers are enabled with a computing system, the designated computer program, and a user interface to view the medical prescription data of the patient and provide the patient with the medication in accordance with the medical prescription of the patient;
ensuring compliance and alerting the plurality of medical practitioners, the patient and the plurality of pharmaceutical service providers; wherein the central server is enabled to provide relevant alerts to the medical practitioners, the patient and the pharmaceutical service providers; and
wherein the central server is in communication with the computing systems of the medical practitioners, the patient, and the pharmaceutical service providers; and
wherein the user interfaces are independently configured for allowing the medical practitioners, the patient, and the pharmaceutical service providers to access, verify, add, or delete the medical prescription data in varying degrees ensuring compliance with the prescription drug management system.
